(19) United States
(12) Patent Application Publication
(10) Pub. No.: US 2008/0217801 A1
(43) Pub. Date: Sep. 11, 2008

(54) Apparatus for forming aggregate composite forms

(76) Inventors: James T. Schneider, Columbus, OH (US); Michael C. Clingerman, Hilliard, OH (US); Gregory R. White, Hilliard, OH (US)

Correspondence Address: BATTELLE MEMORIAL INSTITUTE, 505 KING AVENUE, COLUMBUS, OH, 43201-2693, US

(21) Appl. No.: 11/906,346

(22) Filed: Oct. 1, 2007

Related U.S. Application Data
(60) Provisional application No. 60/848,160, filed on Sep. 29, 2006.

(51) Int. Cl. C04B 40/00; B28B 7/28

(52) U.S. Cl. 264/82; 249/175

(57) ABSTRACT

Broadly, the invention provides for apparatus to form and gas-cure composite and or aggregate materials while controlling the flow of compound at a desired concentration and pressure.

This application claims the benefit of U.S. Provisional Application No. 60/848,160, filed Sep. 29, 2006. The entire content of the provisional application is incorporated by reference herein.

### FIELD OF THE INVENTION

The present invention provides for typically portable, small benchtop apparatus that can be utilized to cure bound aggregates of varying shapes, foundry aggregate forms, non-foundry “films”, non-foundry aggregates, semisolids, fibers, mats, wood panels, construction aggregates, petrochemical-based composites, films, and/or other specialized industrial applications that require a chamber for gassing with a catalyst or similar material through a structure, composite, shape, fiber, film or bound aggregate.

### BACKGROUND OF THE INVENTION

Cold box binders for foundry forms (cores and molds) are cured by passing a reactive gas through resin-coated aggregate. The resin cures within seconds of contact with the gas to produce a hardened core or mold. The equipment to perform these tasks must be able to contain the reactive gas as these gases are typically noxious, and control the amount of the gas going into the resinous sand. In the field, the machines performing these operations are called “core blowers” as the resinous sand is blown by gas pressure into the molds for the aggregate forms, followed by a gassing cycle to cure the aggregate mix, then by purging with air, nitrogen, or another inert gas to remove the noxious catalyst gas from the cured aggregate mix.

When testing for effectiveness, a smaller version of these core blowers is typically utilized. Though smaller, this test equipment is still bulky and rather expensive, utilizing specialized parts manufactured by a select few companies. The size and expense puts this type of equipment out of reach of smaller labs attempting to compete in this technical business area. A small, less expensive unit is needed to allow smaller companies to test cold box aggregate binders.

In addition to the evaluation of non-foundry films, composites, aggregates or similar structures, a re-design of an existing foundry style cold box gassing unit was necessary to allow for the testing of similar or new chemistries that could utilize a gas cure mechanism.

### BRIEF DESCRIPTION OF THE INVENTION

The present invention provides for compact device that can be utilized to cure composite materials in various conformations by exposing the uncured composite to catalytic gas vapors. Large scale equipment is used in the foundry industry, for example, to cure curing aggregate forms into cores and molds for the purposes of making cast metal forms. In the case of foundry equipment, the aggregate is mixed with a curing binder, then “blown” by gas pressure into molds the mixed resinous aggregate then has the catalytic gas passed through it, which causes rapid curing. This process is referred to as the “cold box” process. Laboratories have smaller units for testing the binders that bond these forms. These units are large and bulky and cost prohibitive. These units typically require the installation of additional specialized auxiliary equipment for the control of application conditions that adds further to the bulk and cost.

There are four drivers for this invention; the need for cold box test equipment that is compact and affordable, the need for gas-curing test equipment for a wide variety of composite curing, aggregate curing or semi-porous liquids, fluids or films based upon gas or phase-cured technology, the need for a low-cost, low maintenance, easily adaptable apparatus that is easy to use and can be quickly learned and the need for an apparatus that uses a modular construction based on commonly purchased parts.

This document describes a small, accurate, portable, modular, low cost, low maintenance gas-curing unit that is easily constructed out of mostly pre-manufactured modular equipment currently on the market, used in a standard sized laboratory hood, lightweight, portable, low cost and can very accurately dispense a controlled amount of a variety of catalytic gases into an uncured composite matrix such as the resinous aggregate used in cold-box foundry binders. This invention also solves several issues with existing equipment, including size, mobility, and the ability to deliver from 0.5 cc/minute up to over 1,000 cc/minute very accurately and repeatably.

### BRIEF DESCRIPTION OF THE DRAWINGS

FIG. 1 is a schematic drawing illustrating a mechanical layout of the major components of the invention.

FIG. 2 is a schematic illustrating in a simplified electrical sketch the electrical connection layout for the control panel portion of the invention linking the solenoids, timers, on/off switches, indicator/totalizer, and toggle switch.

FIG. 3 is a schematic diagram of a typical spray head/expansion chamber with attached fluid body, fluid cap and gas cap.

FIG. 4 is a schematic diagram of a gassing manifold, booth or chamber with main components. This particular diagram shows a gassing manifold, match plate, sidewall height adapter and the bottom plate section.

FIG. 5 is a schematic drawing of the transmitter as it resides atop the flow meter. The transmitter is typically installed by the flow meter manufacturer as a unit.

FIG. 6 is a schematic drawing that shows the transmitter and its relationship to the indicator/totalizer located on the control panel.

FIG. 7 is a schematic diagram of a typical gassing manifold.

FIG. 8 is schematic diagram of a typical cavity in the shape of a “dog bone” in a core box.

FIG. 9 is a schematic diagram of a typical match plate for providing gas flow to each cavity in the curing box.

### DETAILED DESCRIPTION OF THE INVENTION

The Invention consists of several distinct “sections” that when combined together, form a fully functional gassing unit capable of turning low-range flash point fluids, or existing gasses into a vaporized or atomized state that is then transferred through a series of heat-traced lines to a core box, gassing unit or gassing booth that may or not contain specific cavity shapes for holding aggregate, fluid or semi-porous materials, or hold permeable films for curing via this equipment.

The invention is a small, accurate, portable, modular, low cost, low maintenance gas-curing unit that is easily constructed out of mostly pre-manufactured modular equipment currently on the market, used in a standard sized laboratory hood. Its lightweight, portable, low cost, low maintenance and other features make it ideal for small laboratories or for transport to various sites.

The majority of components can be purchased through well known and established suppliers of flow meters, electrical components, timers, tanks and associated mechanical and electrical equipment. These suppliers included; W.W. Grainger, McMaster-Carr and Freeman Manufacturing.

Heat-traced lines and controllers were purchased through TempCo Electric Heater Corporation, 607 N. Central Avenue, Wood Dale, Ill. 60191 (www.tempco.com).

Several items are fabricated to make the unit more efficient. The expansion chamber was fabricated specifically to fit the chosen fluid body, fluid cap and gas cap arrangement. Typically, an adapter can be purchased to attach the fluid cap to another pipe fitting or opening.

The invention can be broken down into several distinct segments for ease of construction, transport, maintenance, troubleshooting and incorporation into specific laboratory or other modes.

Segment 1—Pressure Tank containment system; contains the chemical fluids that are to be vaporized or atomized. The pressure valve, dip tube, and pressure regulator are part of this section.

Segment 2—Control Panel; contains the timers, start/stop buttons, switches, totalizers, indicators or other electrical connections, except those associated with the external heaters for the lines and expansion chamber.

Segment 3—Heating Element and transfer lines; allows material movement from the containment structure and carrier materials through the meters, valves and nozzle assembly to the gassing structure or booth. This includes the heated lines, expansion chamber band heater, heater controllers, 2 and 3-way valves, pipe fittings and connectors.

Segment 4—Flow Meter assembly; which includes an in-line 10-micron filter, piston-style flow meter and calibrated transmitter. These components are combined as a set by the manufacturer to the specific requirements of the materials being atomizer or vaporized including the indicator/totalizer.

Segment 5—Spray Head Nozzle Assembly; includes the fluid body, fluid cap, gas cap, 1-way valve and expansion chamber.

Segment 5—Solenoids; includes the liquid materials solenoid, gas solenoid and carrier gas solenoid.

Segment 7—Gassing Unit; containing the gassing manifold, match plate, core box, booth, and associated wall adapters, fittings, vents, seals and enclosures.

Segment 8—Gas/Air Source; includes the carrier gas, purge gas, air/gas desiccators, pressure regulators, valves and associated equipment and fittings.

### Equipment Design/Diagrams/Schematics

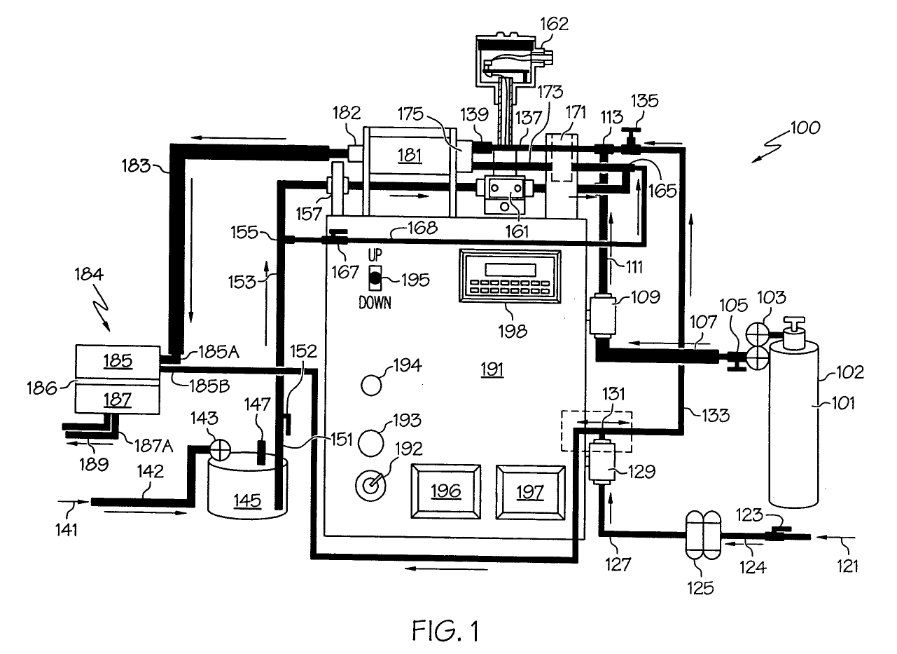

Referring now to FIG. 1, the figure is a schematic diagram that outlines and details major portions of the amine gassing unit 100. Liquid and gas flow directions are indicated by arrows along various flow lines in the figure. Inert gas (e.g. nitrogen) 101 in tank 102 flows via a pressure regulator 103 to a valve 105 and then to heat traced inert gas line 107 to a nitrogen solenoid 109 that controls nitrogen gas flow to the expansion chamber 181 via pipe tee 113, line 137 and fluid body 175.

Gas flow 121 is controlled by a shutoff valve 123. Gas flows via line 124 to a desiccant gas dryer 125, then to line 127 to gas solenoid 129. Gas then flows to T-divider 131. It is noted that the gas line at T-divider 131 is typically placed to the valve 135 or to the manifold 185 at inlet 185B. Lines 133 or 137 for gas flow are placed as needed to valve 135 or inlet 185B. Gas then flows to pipe tee 113 where it may mix with inert gas from line 111 and flow to the expansion chamber 181 via line 137 and fluid body 175.

Amine is stored in a pressure tank 145 typically having a pressure safety valve 147, a pressure regulator 143 where pressurized dry gas 141 can enter the tank 145. A dip tube 151 provides for amine flow to a shutoff valve 152, then via line 153 to a pipe tee 155. One branch flows via a gas line to a filter 157 for liquid amine. The filter 157 typically is a 10 micron filter. From the filter the amine flows to the flow meter 161 that is attached to transmitter 162, then to another pipe tee 165 and then to liquid amine solenoid 171. From the liquid amine solenoid 171 liquid amine flows to the expansion chamber 181 via line 173 and fluid body 175. A “bypass” route or method (as referred to later below) for amine from pipe tee 155 is to flow past shutoff valve 167 via line 168 to pipe tee 165 and then to the liquid amine solenoid before flowing to the fluid body of the expansion chamber 181 via line 173.

Once the liquid amine has been gasified and mixed with inert gas/air as desired the amine gas (vapor) flows out of the expansion chamber outlet 182 to a heat traced transfer line 183 (for the amine gas) and then to the inlet 185A of the gassing chamber 184. Gassing chamber 184 consists of gassing manifold 185 having two inlets 185A and 185B, a match plate 186 for interfacing with curing box 187. Curing box 187 has one or more outlets 189 for gas that is vented or captured as in a hood or other device not shown.

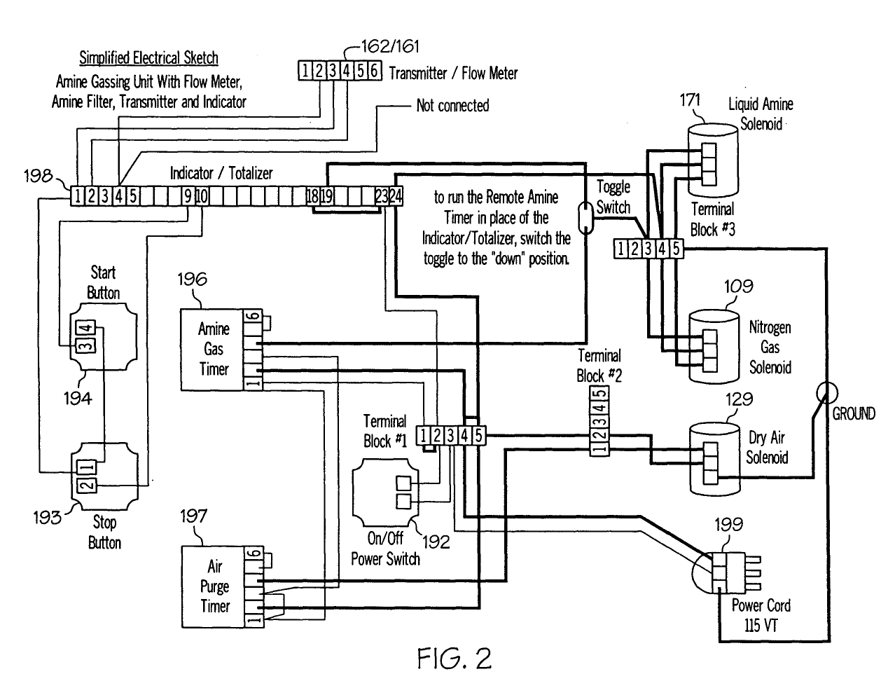

Control panel 191 shows the locations of the on/off power switch 192, remote stop switch 193, remote start switch 194, toggle switch 195 that has an up indicator timer mode and a down amine gas timer mode. Amine gas timer 196, gas purge timer 197 and indicator/totalizer 198 are provided on this panel. Electrical connections between these units on the control panel are given in detail in FIG. 2 below.

Referring now to FIG. 2, this figure illustrates typical electrical connections for the amine gassing unit 100. The various electrical connections between nitrogen gas solenoid 109, dry gas solenoid 129, transmitter/flow meter 162/161, liquid amine solenoid 171, on/off switch 192, remote stop button 193, remote start button 194, toggle switch 195, amine gas timer 196, gas purge timer 197, indicator totalizer 198, and power cord 199 are indicated.

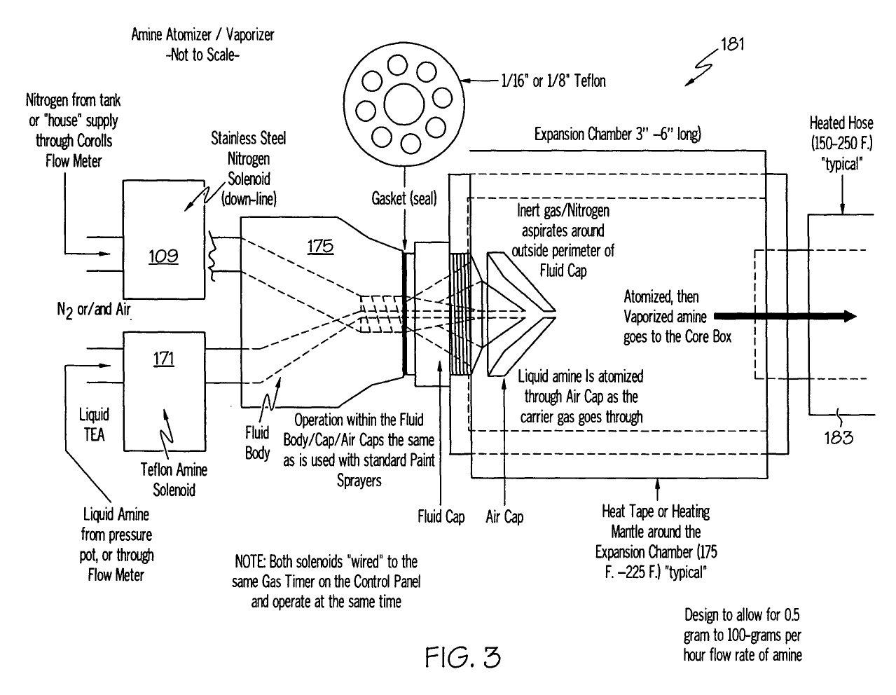

Referring now to FIG. 3, this figure illustrates details of the spray head expansion chamber 181, and connections to the gas (nitrogen) solenoid 109, the liquid (amine) solenoid 171, the spray head 175, expansion chamber 176, and heated transfer line 183. Preferably solenoids 109 and 171 are connected to the same timer in the control panel and operate at the same time. The spray head 175 typically consists of a fluid body 177, a fluid cap 178, and an air cap 179. A gasket 177A is typically of Teflon™. Operation of the spray head is typically like that used in paint sprayers. Typically the second pressurized gas aspirates around outside perimeter of the fluid cap 179 while the liquid compound is atomized through the air cap 179 as the gas goes through it and thus breaking the liquid into tiny droplets that then vaporize easily in the heated expansion chamber heated by heater 176A. A typical design as shown can provide from 0.5 to 100 g per hour of catalyst such as an amine catalyst.

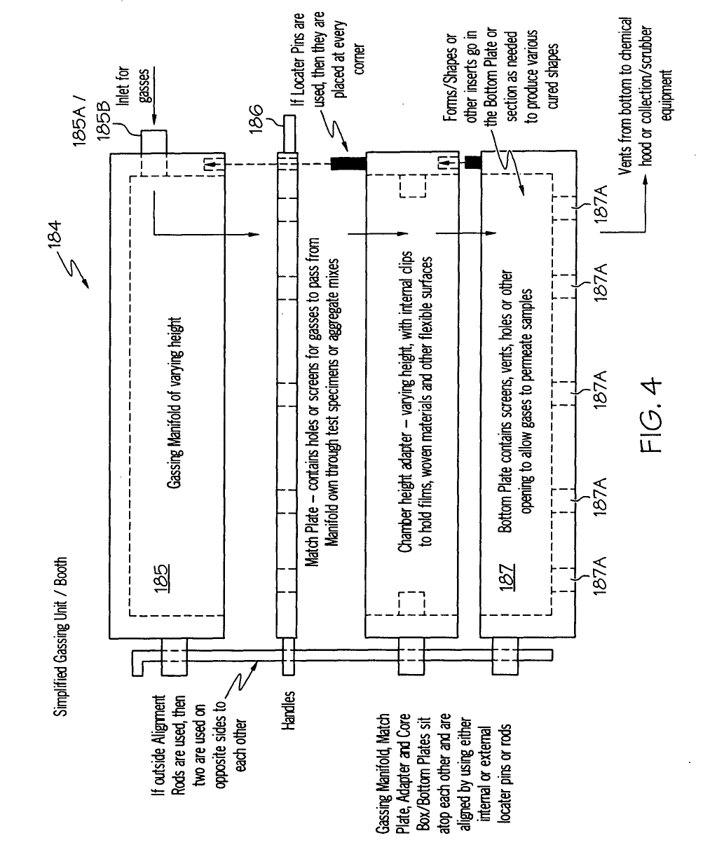

Referring now to FIG. 4, the figure is a schematic diagram of a gassing chamber 184 having a gassing manifold 185, match plate 186, chamber height adapter 186A, and bottom plate 187. The gassing manifold 185, match plate 186, sidewall height adapter 186A and the bottom plate section 187 are typically placed atop one another as shown and are aligned by using either internal locator pins 184B or external alignment rods 184A. Alignment rods 184A are used on opposite sides of each other. Locator pins 184B are typically used at every corner. Match plate 186 contains holes 187B or screens (not shown) for gasses to pass form the manifold 185 down through the test specimens or aggregate mixes 187B that are typically placed in the bottom plate 187.

Table 1 lists the parts used for the atomizing segment. These parts are manufactured by Spraying Systems Company, P.O. Box 7900, Wheaton, Ill. 60189-7900.

TABLE 1

| | Old Number | New Number |
|---|---|---|
| Item | Designation | Designation |
| Fluid Body | ¼ JBC | ¼ JBC-SS |
| Fluid Cap | SS 1250 | PF 1250-SS |
| Air Cap | 64 SS | PA 64-SS |

Table 2 lists the parts used for the flow meter, transmitter, filter and indicator/totalizer available from Max Machinery Inc., 1420 Healdsburg Avenue, Healdsburg, Calif. 95448, web address www.maxmachinery.com.

TABLE 2

| Product | Description | Serial Number |
|---|---|---|
| 13-313-720 | Model 213 Flow Meter | C603005 |
| 286-323-000 | 286 Series Transmitter | C551307 |
| 121-200-000 | Model 121 Indicator/ | C130120 |
| | Totalizer | |
| 381-102-720 | 10 micron Filter | 019-036 |
| | | element |

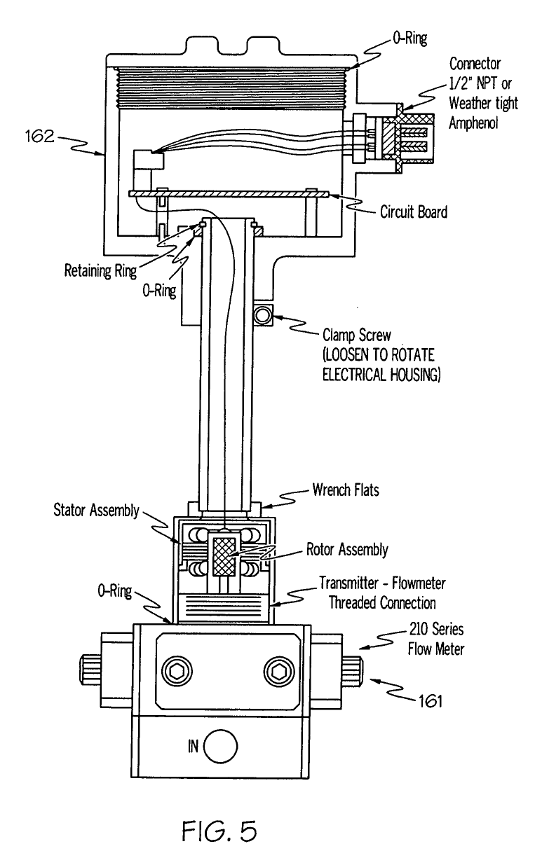

Referring now to FIG. 5, this figure illustrates details of the flow meter 161 and transmitter 162. A circuit board 162A for electronics is typically located in transmitter 162 and the stator and rotor assembly are typically located in the flow meter 161. A 210 Series™ flow meter is typical.

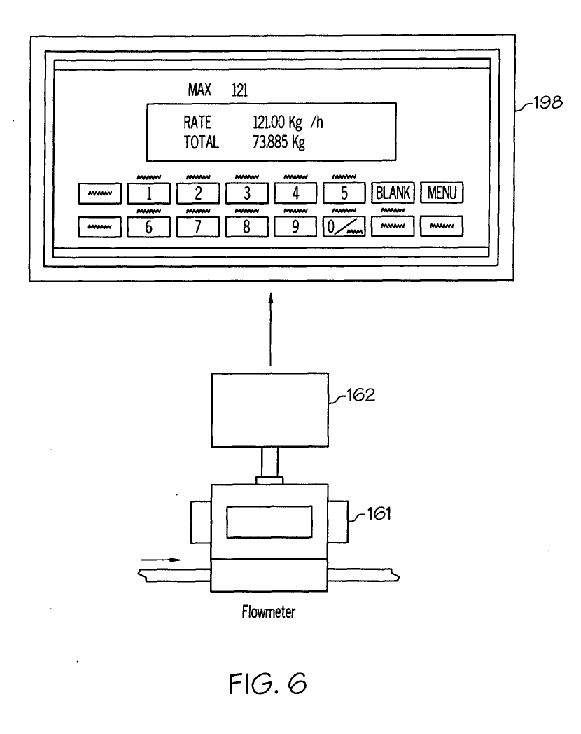

Referring now to FIG. 6, this figure illustrates the flow meter 161 and transmitter 162 and their relationship to the indicator/totalizer located on the control panel.

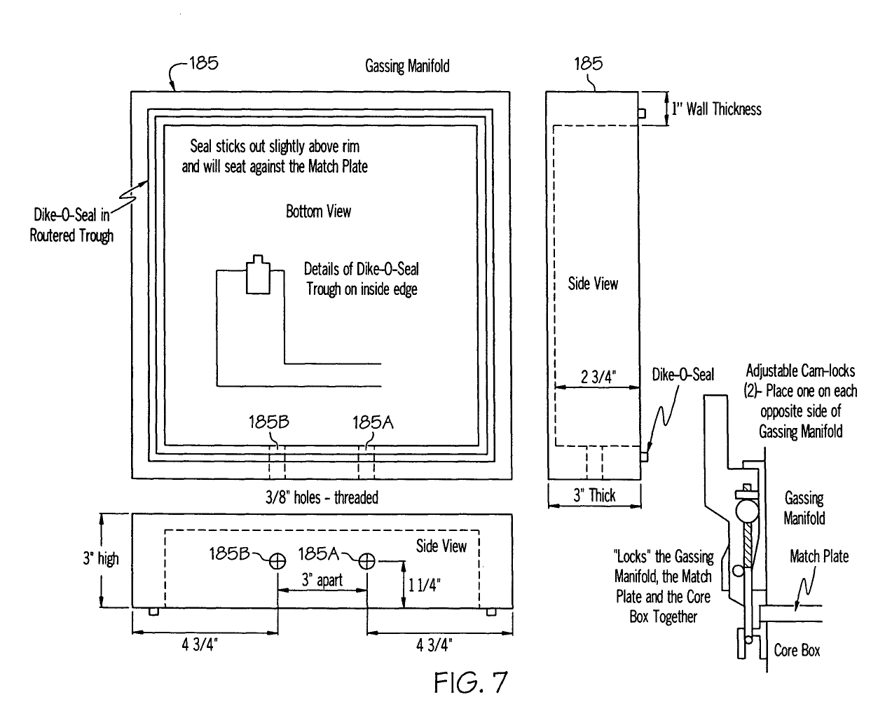

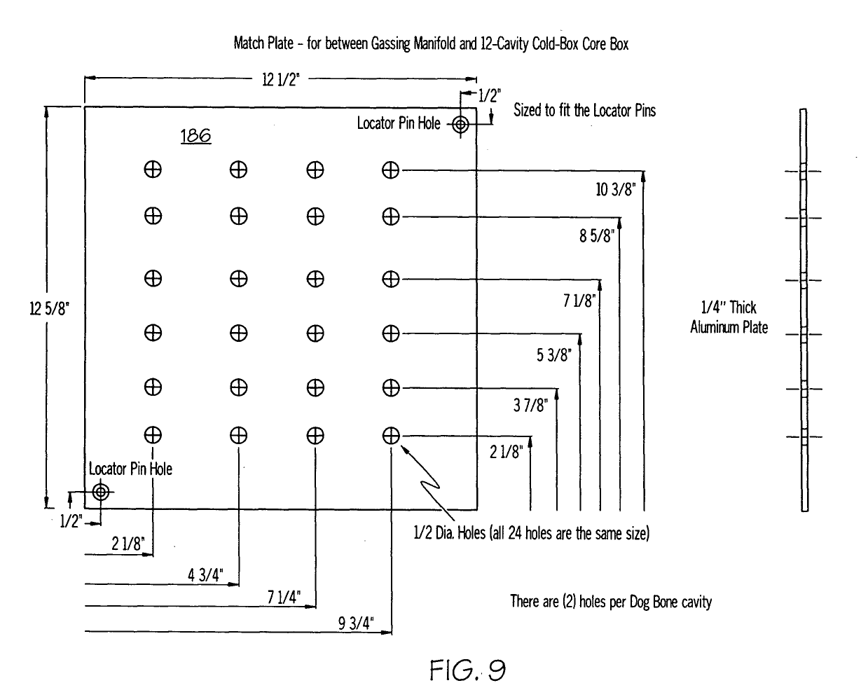

Referring now to FIGS. 7 (gassing manifold 185), 8 (curing box 187) and 9 (match plate 186). FIGS. 7, 8 and 9 illustrate typical designs for fabricating a simplified gassing booth or gassing chamber 184 for producing laboratory foundry core shapes. A typical dog bone cavity 801 is shown. Typical holes 186B are shown in match plate 186 of FIG. 9.

The bottom portion, consisted on a standard 12-cavity aluminum dog bone gang box manufactured by Piteo Manufacturing Company, 5900 Highway 321 North, Lenoir City, Tenn. 37771, that was further modified by a local machine shop to include a perform 20 Durometer seal, commonly known as Dike-O-Seal, around the perimeter and a set of standard size 3 male and female locator pins 184B. These locator pins 184B were set at opposite corners with a height sufficient to pass through the thickness of the match plate into the bottom portion of the top gassing manifold. Holes were drilled and three 50 mesh, Type K, ⅜″ diameter screened vents were placed at the bottom of each dog bone cavity.

### How the Gassing Apparatus Functions

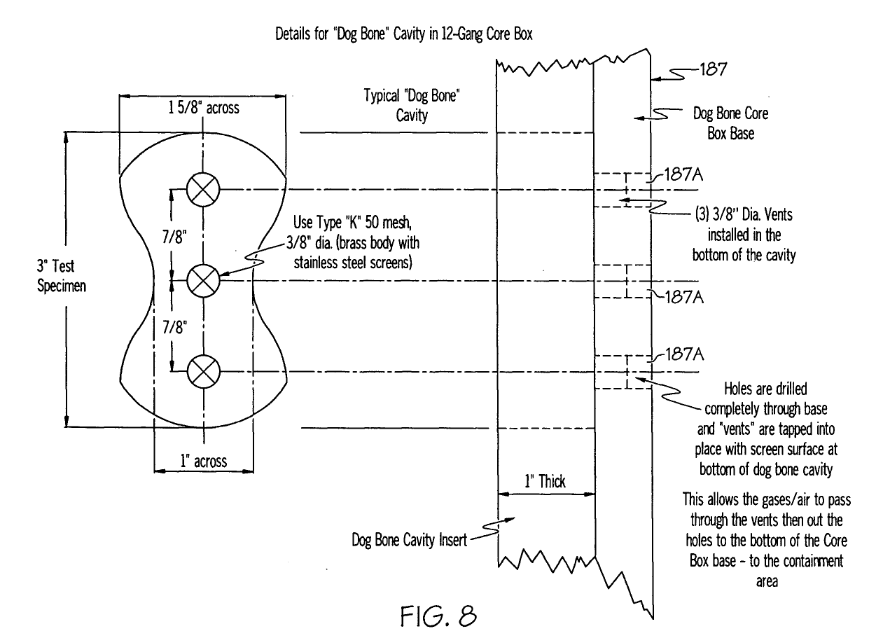

Essentially, to cure a laboratory cold-box aggregate test specimen used within the foundry industry, it is necessary to place an aggregate mix, containing a selected type of sand coated with a small amount of gas-curable resin into a standard shape. In this case, the shape happens to be known within the foundry industry as a standard AFS (American Foundry Society) “dog bone” of known proportions, see FIG. 8.

The resin used in one of these processes was a phenolic-urethane resin that is catalyzed to a hardened shape within a few seconds by using an amine gas or vapor. The amine gas or vapor acts as a true catalyst. It is passed in the vapor phase through the sand mix, hardening the sand mix. The amine then exits the forms used for making the shapes by means of vents, typically located opposite the injection area. In this case, the amine enters the aggregate sand mix from the gassing manifold, through the match plate to the aggregate sand mix. It then passes through the specific mixed sand shape, maintained by particular patterns in the bottom half on the mold or box then through an exiting vent to the atmosphere, chemical hood, or other arrangement for collection elsewhere. Within the foundry environment, the amine is typically guided by means of vents through a series of collection tubes to a chemical scrubber.

In order to inject or administer the vaporized amine through the aggregate mix, the amine must be atomized and/or vaporized at some point prior to it passing through the aggregate mix. This is accomplished by pressurizing the liquid amine (flash point=14.4° C.) in a containment vessel. The containment vessel used was a 3.79 liter stainless steel pressure tank. The pressurized liquid amine is forced through a series of lines to a liquid amine solenoid. The liquid amine solenoid is opened and closed by means of an amine gas timer located on the control panel.

As the liquid amine is allowed to pass through the liquid amine solenoid, it flows to a spray head assembly, which is attached directly to an expansion chamber. The expansion chamber is typically heated and in this case was heated to be between about 37.8° C. and about 148.9° C.

There are two distinctly different methods that were used with present invention to move the liquid amine to the spray head assembly. One is strictly by means of the pressure differential in the liquid amine tank forcing the liquid amine to the liquid amine solenoid, where it is allocated to the spray head assembly by the amine gas timer. The difference in pressure, the line diameter and time of allocation used determines the amount of amine that will eventually be passed through the mixed aggregate.

The second and preferred method is by using minimal backpressure within the liquid amine tank to keep the liquid amine flowing through the transfer lines to the flow meter, where the liquid amine is moved with a high degree of precision to the liquid amine solenoid. The flow meter, liquid amine solenoid and nitrogen carrier gas solenoid are controlled by the indicator/totalizer located on front of the control panel. This preferred method shows an extremely high degree of accuracy that will allow the liquid amine to be metered anywhere from about 1.0 ml/minute to more than about 94.6 liter/minute depending on the flow meter, transmitter and indicator chosen. This method saves the end user amine or other catalytic material and greatly improves accuracy of a laboratory experiment.

In both cases, once the liquid amine flows past the spray head assembly, where it is first atomized, the atomized particles pass into the expansion chamber where the atomized particles are then vaporized by the external band heater wrapped around the chamber. The chamber acts as a collection point from which the vapors can be moved onwards.

Also, in both cases, as the liquid amine solenoid opens to allow the liquid amine to flow through the spray head assembly, the nitrogen gas (or other inert carrier gas) enters at the same time. The nitrogen gas solenoid is electrically connected to the same contacts as the liquid amine solenoid so both open and close together.

As the liquid amine passes through the spray head assembly, the nitrogen is also passing through the spray head assembly. This causes the atomization of the liquid amine at the ejection point at the tip of the spray head assembly. In effect, it is the same principle as is used to spray paints, varnishes and other coatings. Small droplets are formed.

The small droplets are useful as a means to vaporize the amine catalyst. The vapor phase allows the amines or other materials to pass more efficiently through the aggregates or other materials being cured. It also allows for much less catalyst to be required.

The nitrogen carrier gas is furnished by means of a typical nitrogen cylinder with a regulator and valve assembly or other means such as an “in house” line system. The gas as it exits the cylinder enters a heated transfer line to “pre-warm” the gas before it enters the spray head assembly. By using heated nitrogen, it assures an easier vaporizing of the amine and assists in maintaining it in a vapor phase.

The combination of warm nitrogen and vaporized amine, now in the expansion chamber, passes through a heated amine gas line directly to the gassing manifold. Once again, the use of a heated amine gas line ensures that there will not be any reformation of liquid amine prior to it entering the gassing manifold.

The gassing manifold and associated match plate, bottom plate or other forms used to hold the shapes being gassed could also be heated in a similar fashion to further ensure no amine or other catalyst “drops out” to a liquid phase before catalysis of the materials takes place.

The amine or other catalyst passed through the aggregate, shape, or materials to be catalyzed, then out the bottom of the gassing unit through a series of vents to a collection point or it can be vented to the atmosphere.

Any laboratory or field aggregate, film, semi-permeable material, cellular structure, woven fiber, coating or similar material requiring a technique to vapor or atomize the catalyst for solidification of that material can be evaluated or produced, as in production, using this apparatus. The size of the gassing chamber, manifold, core box, bottom box or enclosure can be resized as needed to hold the shapes for catalyzing.

The gassing apparatus itself can be modified to include two or more solenoids, timers, flow meters or similar parts to incorporate multiple carrier gasses or multiple amines or multiple catalysts. This includes the addition on multiple heated lines and other plumbing.

### EXAMPLES

The examples herein are exemplary of some aspects of the invention and are not intended to limit the scope of the invention in any way.

An initial design of the gassing apparatus centered on producing a typical laboratory test core specimen used within the foundry industry.

### Example 1

A series of sand mixes were made using industry standard readily available phenolic-urethane cold-box binders and Wedron 540 silica sand. The amine chosen for this example was triethylamine (TEA), a typical foundry catalyst used worldwide for curing various cores and molds for high production operations.

The resin was mixed using a 55:45 of Part I (phenol-formaldehyde resin) to Part II (isocyanate and solvents) and mixed on the sand at 1.25% based on the weight of the resin.

The sand mix was hand packed into standard American Foundry Society (AFS) dog bone forms located in the bottom portion of the gassing unit. The match plate was then placed on top of the core box (bottom portion), and then the gassing manifold was placed on top of the match plate.

All three sections were clamped together and placed in the laboratory hood. The amine gas line was attached to the gassing manifold after the gassing apparatus lines and timers were set for the specific evaluation.

Table 3 shows the initial settings for line temperature and pressure during the test phase.

TABLE 3

| | | Pressure | Time |
|---|---|---|---|
| Item | Temperature | (psi) | (sec) |
| Heated Nitrogen Line (from the Nitrogen tank) setting | 225 F. (107.2 C.) | 50 | |
| Heated Amine Gas Line (to the Core box) setting | 225 F. (107.2 C.) | | |
| Band Heater (around the Expansion Chamber) | 200 F. (93.3 C.) | | |
| setting | | | |
| Heated Nitrogen Line (from the Nitrogen tank) - | 112 F. (44.4 C.) | | |
| External shroud | | | |
| Heated Amine Gas Line (to the Core Box) - External | 106 F. (41.1 C.) | | |
| shroud | | | |
| Amine Tank Backpressure setting | | 2 | |
| Gas and Nitrogen Solenoid Timer setting | | | 6 |
| Gas Purge Solenoid Timer setting | | | 15 |
| Gas Purge line from supply to Gas Solenoid | | 40 | |
| Top of Expansion Chamber cover | 109 F. (42.8 C.) | | |
| Fluid Body Temperature (2 inch from Expansion | 88 F. (31.1 C.) | | |
| Chamber) | | | |
| Amine Gas Line connector (2 inch from Expansion | 84 F. (28.9 C.) | | |
| Chamber) | | | |

Several sets of 12 dog bones were completely cured using these variables. Test specimens showed 100% cure with initial tensile strengths of above 180 psi using a Thwing Albert QC-3A Tensile Tester set at 2 inches/minute crossbar speed and 0.2 inches/minute crossbar speed once contact with the test specimens was made. The load cell used was a standard 1,000 psi load cell from the same manufacturer.

After the cure cycle, minimal amine odor was noted on the samples. No puddling or liquid amine was noted at any location.

### Example 2

Several mixtures of sand and phenolic-urethane resin were made and evaluated with various settings of time and pressures using the “bypass” method, or not using the flow meter. Results of amine volume were calculated with the liquid amine pressure tank set from 2 to 12 psig back pressure and with the amine gas timer set from 2 to 10 seconds. From the data, calculations were made and a chart developed as shown in Table 4.

TABLE 4
Amine Tank Pressure Setting vs. Amine Flow Rate through Fluid Cap @ 68° F.
Fluid Body = ¼ JBC. Fluid Cap = SS 1250. Air Cap = 64 SS. ¼″ dia.
SS Braided pressure lines

| | | Seepage | | | | | Seepage | | |
|---|---|---|---|---|---|---|---|---|---|
| AmineTank | | after timer at | Amine | | AmineTank | | after timer at | Amine | |
| Pressure | Gas Time | zero | amount | Volume | Pressure | Gas Time | zero | amount | Volume |
| (psi) | (seconds) | (seconds) | (grams) | (cc)*** | (psi) | (seconds) | (seconds) | (grams) | (cc)*** |
| 2 | 2 | 1-2 | 0.33 | 0.24 | 8 | 2 | 3-5 | 0.77 | 0.56 |
| 2 | 4 | ″ | 0.49 | 0.36 | 8 | 4 | ″ | 1.10 | 0.80 |
| 2 | 6 | ″ | 0.66 | 0.48 | 8 | 6 | ″ | 1.58 | 1.15 |
| 2 | 8 | ″ | 0.84 | 0.61 | 8 | 8 | ″ | 2.06 | 1.50 |
| 2 | 10 | ″ | 1.04 | 0.76 | 8 | 10 | ″ | 2.34 | 1.70 |
| 4 | 2 | 2-3 | 0.61 | 0.44 | 10 | 2 | 3-7* | 0.64 | 0.46 |
| 4 | 4 | ″ | 0.98 | 0.71 | 10 | 4 | ″ | 1.06 | 0.77 |
| 4 | 6 | ″ | 1.25 | 0.91 | 10 | 6 | ″ | 1.62 | 1.18 |
| 4 | 8 | ″ | 1.47 | 1.07 | 10 | 8 | ″ | 1.99 | 1.44 |
| 4 | 10 | ″ | 1.74 | 1.26 | 10 | 10 | ″ | 2.75 | 2.00 |
| 6 | 2 | 2-4 | 0.60 | 0.44 | 12 | 2 | 8-16** | 0.81 | 0.59 |
| 6 | 4 | ″ | 1.01 | 0.73 | 12 | 4 | ″ | 1.09 | 0.79 |
| 6 | 6 | ″ | 1.36 | 0.99 | 12 | 6 | ″ | 1.82 | 1.32 |
| 6 | 8 | ″ | 1.93 | 1.40 | 12 | 8 | ″ | 2.80 | 2.03 |
| 6 | 10 | ″ | 2.26 | 1.64 | 12 | 10 | ″ | 3.25 | 2.36 |

The chart developed can be used to preset the gassing apparatus for curing various aggregates or other materials based on the amounts of amine needed. A simplified view of this chart is shown in Table 5.

TABLE 5

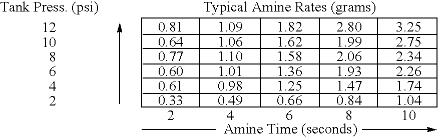

### Example 3

The “flow meter” method consists of shutting off the “bypass” lines for the liquid amine and allowing the liquid amine to continue through the flow meter to the liquid amine solenoid as previously outlined. With this method, the amine gas timer is not used. All variables for the liquid amine are set using the indicator/totalizer on front of the control panel.

Using this method ensure an exact amount of amine goes to the spray head assembly during a predetermined time and using specific instructions for volumes per second or per minute based on ambient conditions. This method allows the operator to set the time intervals and amounts per selected time to the aggregate or items to be catalyzed.

The flow meter, transmitter and indicator/totalizer work together and are based on electrical current, liquid densities and pulses per second from the flow meter and transmitter. A few of these variables are shown in Table 6.

TABLE 6

| Variable | Input Value | Variable | Input Vale |
|---|---|---|---|
| Item: | Value | Flow Input: | 12 VT |
| Rate Type: | Batch | Flow Input Type: | Pulse |
| Max Batch Preset: | 6 cc | Low Flow Rate: | 0.20 cc/sec. |
| Batch Comp: | No | High Flow Rate: | 0.70 cc/sec. |
| Auto Batch: | Off | Avg. K-Factor: | 100 P/cc |
| Flow Equation: | Volume | K-Factor Type: | Average |
| Indicator Total: | Density | Ref. Density: | 0.72 gm/cc |
| Indicator Rate Base: | Sec. | Ref. Temp: | 60 F. |
| Indicator Temp: | F. | | |
| Density: | Grams | | |
| Quick Update: | 25% | | |
| | | S4-1: | Set at “210” |
| S1-1: | Set for “Open” | S4-2: | Set for “Comb |
| | | | Out” |
| S1-2: | Set for “Filter” | S3: | #8 |

### Parts/Materials

Parts and materials for the typical fabrication illustrated herein are shown in Table 7 and were purchased through well established suppliers to ensure reliability, part exchange and replacement if needed.

TABLE 7

| Company | Item | Part # | Needed |
|---|---|---|---|
| Max Machinery Inc | Flow Meter | 213-313-720 | 1 |
| | Transmitter | 286-323-000 | 1 |
| | Indicator & Flow Totalizer | 121-200-000 | 1 |
| | System Test & Calibration | 121-800-000 | 1 |
| | 10 Micron 316 SS Filter | 381-102-720 | 1 |
| McMaster-Carr | 1-Gal. SS Pressure Tank | 6778K18 | 1 |
| | 304 SS Safety Valve | 98905K15 | 1 |
| | 2.5″ SS 0-60 psi Pressure Gauge | 4066K41 | 1 |
| | 4-foot SS braided PTFE lined Hose | 4552K212 | 2 |
| | PTFE ⅜″ diapharam Solenoid Valve (for Amine) | 7911K13 | 1 |
| | ⅜″ 303 SS Solenoid Valve 120T (for Nitrogen) | 8214K63 | 1 |
| | ⅜″ 100-psi Brass Solenoid Valve (for Air) | 8077K48 | 1 |
| | Toggle Clamp Pull-action | 5071A53 | 2 |
| | Enclosure 16-Gauge, 20″ × 16″ × 8⅝″ (Control Panel) | 7561K55 | 1 |
| | Quik-Connects Male | ? | 6 |
| | Quik-Connects Female | ? | 6 |
| | Ball Valve, stainless steel, ¼″ pipe 316ss | 46495K58 | 2 |
| Grainger | Countdown Timer 120vt | 6PY50 | 2 |
| | Push style A-B Green Button | ? | 1 |
| | Push style A-B Red Button | ? | 1 |
| | Power Switch | ? | 1 |
| TempCo | Heated Hose, HEHR0600601201ABMMSP (5 ft.) | | 2 |
| | Temperature Controller (Control Console) | TPC-1000 | 2 |
| Spraying Systems | ¼″ JBC SS (Stainless Steel) Fluid Body | | 1 |
| Company | | | |
| | PF 1250 SS (Stainless Steel) Fluid Cap Assy. | | 1 |
| | PA 64 SS (Stainless Steel) Air Cap | | 1 |
| Freeman Mfg. Co. | 50 mesh, Type K, ⅜″ dia. Screened vents | 33194 | 36 |
| | Perform Seal, 20 Durometer, Dike-O-Seal | 177105 | 16 |
| | Female Bushing (Locator Pin), Size 3 | 161170 | 2 |
| | Male Bushing (Locator Pin), Size 3 | 161150 | 2 |
| Machine Shop | Gassing Manifold | | 1 |
| | Match Plate | | 1 |

While the forms of the invention herein disclosed constitute presently preferred embodiments, many others are possible. It is not intended herein to mention all of the possible equivalent forms or ramifications of the invention. It is to be understood that the terms used herein are merely descriptive, rather than limiting, and that various changes may be made without departing from the spirit of the scope of the invention.

We claim:

1. Apparatus for generating a supply of gaseous fluid of a compound at a desired concentration and pressure P3 comprising:
a. an inlet line for conveying pressurized gas at a pressure P1, from a source, through a first pressure regulator to a pressure tank;
b. the pressure tank retaining a reservoir of the compound in its liquid phase;
an outlet line from the pressure tank connected to the inlet of an optional filter or when no optional filter is present to the inlet of a flow control meter;
c. the outlet of the optional filter when present connected to the inlet of a flow control meter for regulating the flow of liquid compound;
d. the outlet of the flow meter connected to the inlet of a liquid control solenoid for controlling the flow of liquid compound;
e. the outlet of the liquid control solenoid connected to a liquid inlet of a spray head/expansion chamber wherein liquid compound is vaporized and mixed with a gas to produce a gaseous fluid compound;
f. a source of second pressurized gas at pressure P2 having an outlet connected to the inlet of a gas solenoid for controlling the flow of second pressurized gas;
g. the gas solenoid having an outlet connected to a gas inlet of the spray head/expansion chamber; and
h. the spray head/expansion chamber having an outlet connected to a transfer line that connected to the inlet of a gassing chamber for application of the gaseous fluid compound at a desired concentration and pressure P3.

2. The apparatus according to claim 1, a heater at the spray head/expansion chamber for heating.

3. The apparatus according to claim 1, wherein the spray head/expansion chamber includes a spray head nozzle assembly.

4. The apparatus according to claim 1, wherein the gassing unit comprises a chamber for producing foundry core shapes.

5. The apparatus according to claim 1, wherein a bypass line with an on/off valve is installed around the flow control meter.

6. The apparatus according to claim 1, comprising an optional supply of purge gas connected to the inlet of a second gas solenoid for controlling the flow of the purge gas and having an outlet connected to the gas inlet of the spray head/expansion chamber.

7. The apparatus according to claim 1, comprising an optional supply of purge gas connected to the inlet of a second gas solenoid for controlling the flow of the purge gas and having an outlet connected to the of the gassing chamber.

8. The apparatus according to claim 1, wherein the transfer line is heated.

9. The apparatus according to claim 1, wherein the apparatus is portable.

10. A method for using the apparatus of claim 1, comprising:
a. providing a liquid catalyst as the compound;
b. controlling and flowing the liquid compound with the liquid solenoid to an optional filter, or to a flow control meter;
c. when the optional filter is used flowing the filter compound to the flow control meter;
d. controlling the flow of liquid compound and flowing the compound to the liquid inlet of the spray head/expansion chamber;
e. providing and controlling the flow of second pressurized gas with the gas solenoid to the inlet of the spray head/expansion chamber;
f. vaporizing the liquid compound in the spray head/expansion chamber and mixing with the second pressurized gas; and
g. flowing the vaporized compound to the gassing chamber.
